(19) United States
(12) Patent Application Publication
(10) Pub. No.: US 2023/0072741 A1
(43) Pub. Date: Mar. 9, 2023

(54) SYSTEM AND METHOD FOR AUTOMATED TRAILER HITCHING WITH OPTICAL SENSORS AND PROJECTED LASER

(71) Applicants: mohammad shafikul huq, HAMTRAMCK, MI (US); sakura quabili, HAMTRAMCK, MI (US)

(72) Inventor: Mohammad Shafikul Huq, HAMTRAMCK, MI (US)

(73) Assignees: mohammad shafikul huq, HAMTRAMCK, MI (US); shakura shafikul quabili, HAMTRAMCK, MI (US)

(21) Appl. No.: 17/881,595

(22) Filed: Aug. 4, 2022

Related U.S. Application Data
(60) Provisional application No. 63/241,054, filed on Sep. 6, 2021.

(51) Int. Cl. G06T 7/73; G01B 11/14

(52) U.S. Cl. CPC G06T 7/73; G01B 11/14; G06T 2207/30252

(57) ABSTRACT

The invention presented utilizes laser points and/or lines and one or more rear-view optical sensors. The points and lines are projected on the front face of the trailer. The optical sensors capture images of the projected laser points and lines. A controller with memory holding logics processes them to find position and orientation of the trailer front face. The laser device projects laser points or lines on the front face of the trailer or the desired structure. The optical sensors capture images of the laser points and lines. The images are read by a controller that extracts the laser lines and points from the images, The controller then estimates the position and orientation of the trailer or the desired structure from the extracted points and lines. In addition, the system analyzes image of the front face of the trailer and determine the trailer type to determine if any adjustment to backward driving is needed or even if the hauler is compatible with trailer and capable of hitching the trailer at all. The presented invention is a non-invasive technique and so, the trailer face front is left intact.

### CROSS REFERENCE TO RELATED APPLICATION

This application is a continuation application of U.S. Provisional Patent Application No. 63/241,054, filed Sep. 6, 2021 with conformation number 1357, the contents of which are incorporated herein by reference almost in their entirety, with claims unchanged.

### FIELD OF THE INVENTION

The present invention relates to an Advanced Driver Assist System (ADAS) feature. More particularly, the feature helps a driver hitching a trailer to a semi-truck or similar hauling vehicle.

### BACKGROUND

Trailer hitching to a semi-truck or similar hauling vehicle is a difficult task when done manually. It takes both time and effort to do manual hitching. The driver has to be back and forth between the wheel and the hitching joint fixture several times to make the hitching successful.

Several techniques exist in the industry to perform automated hitching of a trailer, most of them needing a target pattern to be posted on the front face of the trailer, an image of which then is captured by an optical sensor to find position and pose of the front face of the trailer. The technique is somewhat invasive; the pattern wears over time and needs repainting. Pattern needs to be illuminated by external light source to be seen by optical sensors and the front face of the trailer needs to be planar.

The presented invention uses active patterns—laser points and/or lines and need no external illumination at night. When used with more than one optical sensor, the trailers' face front can be of any shape and not just planar. In addition, the system analyzes image of the front face of the trailer and determine the trailer type to determine if any adjustment to backward driving is needed or if even the hauler is capable of hitching the trailer. The presented invention is a non-invasive technique and so, the trailer face front is left untouched when hitching is performed.

There are numerous automated trailer hitching patents. The difference among them is in types and number of sensors are used and how they are used. For instance, in U.S. Ser. No. 11/179,982B2, 4 cameras have been deployed to understand the position of the trailer ball compared to the vehicle. In U.S. Ser. No. 10/987,984B2, image coordinates have been used to obtain a sense of position of the trailer and model a path in 3D world based on the coordinates. On the other hand, in US20200307329A1 the controller resides rather in the trailer, not in the towing vehicle. The difference of our invention from the others is that our proposed method uses laser lines and/or points. The clear advantage of this proposed method is hitching trailer with irregular shape and no detectable features.

### BRIEF SUMMARY OF THE INVENTION

The invention presented utilizes laser points and/or lines and one or more rear-view optical sensors. The points and lines are projected on the front face of the trailer. The optical sensors capture images of the projected laser points and lines. A controller with memory holding logics processes them to find position and orientation of the trailer front face. The laser device projects laser points or lines on the front face of the trailer or the desired structure. The optical sensors capture images of the laser points and lines. The images are read by a controller that extracts the laser lines and points from the images, The controller then estimates the position and orientation of the trailer or the desired structure from the extracted points and lines. In addition, the system analyzes image of the front face of the trailer and determine the trailer type to determine if any adjustment to backward driving by the hauler is needed when automated hitching maneuver is made or even if the hauler is compatible with trailer and capable of hitching the trailer at all. The presented invention is a non-invasive technique and so, the trailer face front is left untouched when hitching is performed.

### BRIEF DESCRIPTION OF THE DRAWINGS

System and method of the present invention are illustrated as an example and are not limited by the figures of the accompanying diagrams and flowcharts, in which:

FIG. 1 depicts a deployment scenario of the invention with optical sensor, laser projection device, laser lines projected on trailer front, etc.

FIG. 2 depicts a diagram of how different constituent hardware are connected to each other and different steps and routines are applied to accomplish the hitching.

### DETAILED DESCRIPTION OF THE INVENTION

The terminology used herein for the purpose of describing the system and method is not intended to be limiting the invention. The term ‘and/or” includes any and all combinations of one or more of the associated listed items. As used herein, the singular forms “a,” “an”, and “the” are intended to include the plural forms as well as singular forms, unless the context clearly indicates otherwise. The term “comprising” and/or “comprises” specify the presence, when used in this specification, specify the presence of stated features, steps operations, elements, and/r components, but do not preclude the presence or addition of one or more other features, steps, operations, elements, components, and/or groups/thereof.

If not otherwise defined, all terms used herein have the same meaning as commonly understood by one having ordinary skill in the art to which this invention belongs. Furthermore, terms, such as those defined in commonly used dictionaries, should be interpreted as having a meaning that is consistent with their meaning in the context of the relevant art and the present invention and will not be interpreted in an idealized or overly formal sense unless expressly so defined herein.

In the description of the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. However, the specification and claims should be read with the understanding that such combinations are entirely within the scope of the invention and the claims.

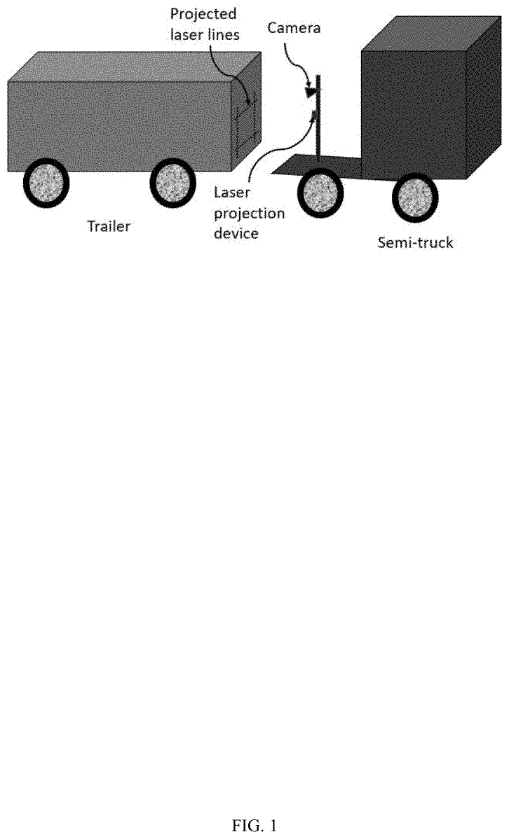

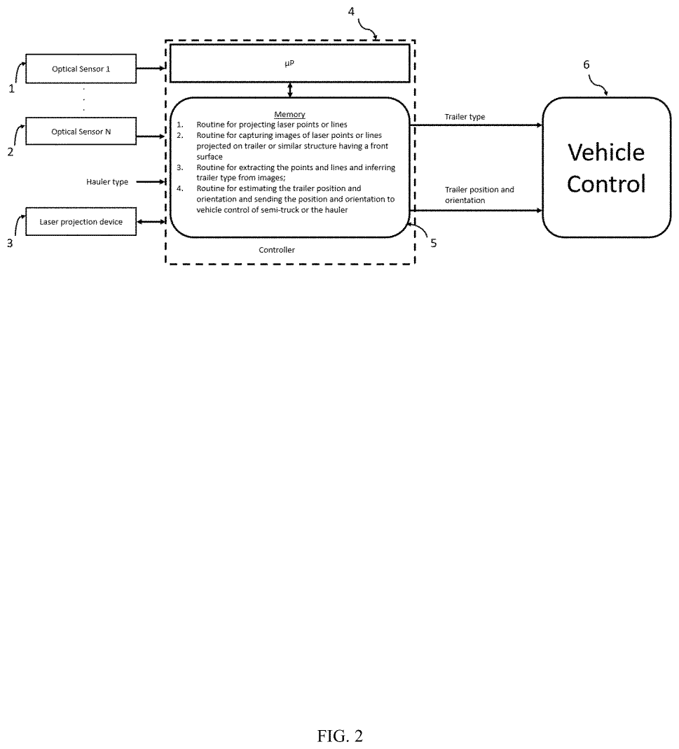

The present invention, a system and method for stopped vehicle driver alert, will now be described by referencing the appended figures, FIG. 1 and FIG. 2, representing the preferred embodiments. The system gives

The invention presented utilizes laser points and/or lines and one or more rear-view optical sensors. The points and lines are projected on the front face of the trailer. The optical sensors capture images of laser points and lines projected by a laser device 3. A controller 4 with memory 5 holding logics processes them to find position and orientation of the trailer front face. The laser device projects laser points or lines on the front face of the trailer or the desired structure. The optical sensors 1, 2 capture images of the laser points and lines. The images are read by a controller that extracts the laser lines and points from the images, The controller then estimates the position and orientation of the trailer or the desired structure from the extracted points and lines. In addition, the system analyzes image of the front face of the trailer and determine the trailer type to determine if any adjustment to backward driving is needed or even if the hauler is compatible with trailer and capable of hitching the trailer at all. The presented invention is a non-invasive technique and so, the trailer face front is left intact.

1. A system to determine position and orientation of a trailer or similar structure, the system comprising:
point laser and/or line laser projecting device;
one or more optical sensor that can capture images of laser points and/or lines projected by the said laser projecting device; and
a controller to extract the projected points and lines from images and calculate the position and orientation of the trailer or structure.

2. A method to determine position and orientation of trailer or desired structures, the said method comprising the steps:
projecting laser points or lines;
capturing images of laser points or lines projected on trailer or desired structure with the optical sensors;
extracting trailer front face lines and the laser points and lines from the images; and
estimating the position and orientation of the trailer or the desired structure from the extracted points and lines.

3. A method as described by claim 2, wherein the said position and orientation of the trailer or the desired structure can also be extracted separately from image of the trailer front face only and combined with the position and orientation extracted from point and line lasers.

4. A method as described by claim 2, wherein the method extracts trailer type from image of the trailer front face only and matches up with the hauler type information to find if they are compatible and a hitching operation is possible to be performed at all.
